(19) United States
(12) Patent Application Publication
(10) Pub. No.: US 2014/0342694 A1
(43) Pub. Date: Nov. 20, 2014

(54) Systems and methods for ordering telecommunication services

(71) Applicant: Level 3 Communications, LLC, Broomfield, CO (US)

(72) Inventors: Paul Farnsworth, Niwot, CO (US); Eric David Gundersen, Broomfield, CO (US); Yunas Nadiadi, Superior, CO (US); Peter Clark Snee, Westminster, CO (US)

(73) Assignee: Level 3 Communications, LLC, Broomfield, CO (US)

(21) Appl. No.: 14/120,283

(22) Filed: May 14, 2014

Related U.S. Application Data
(60) Provisional application No. 61/823,307, filed on May 14, 2013.

(51) Int. Cl. H04M 15/00

(52) U.S. Cl. CPC H04M 15/72; H04M 15/68; H04M 15/721
USPC 455/406

(57) ABSTRACT

Implementations described and claimed herein provide systems and methods for processing telecommunication orders taking advantage of the infrastructure and capabilities of a plurality of different providers. In one implementation, one or more databases store provider data received from a plurality of provider members. The provider data is aggregated based on at least one of a plurality of attributes associated with one or more telecommunication packages. The plurality of attributes include infrastructure information, location information, and pricing information. At least one server is in communication with the one or more databases. The at least one server is configured to generate a design for a customer order based on the aggregated provider data. The design uses at least one of the plurality of provider members to provide a customer telecommunication package at one or more customer sites. The customer telecommunication package is selected from the one or more telecommunication packages.

### CROSS-REFERENCE TO RELATED APPLICATION

The present application claims benefit under 35 U.S.C. §119(e) to U.S. Provisional Patent Application No. 61/823,307, entitled “System for Ordering Telecommunications Services” and filed on May 14, 2013, which is specifically incorporated by reference in its entirety herein.

### TECHNICAL FIELD

Aspects of the present disclosure relate to processing telecommunication orders and in particular to systems and methods for ingesting provider data and for generating a design for providing a telecommunication package taking advantage of different provider members' services, locations, infrastructure, pricing, and the like, among other features and advantages.

### BACKGROUND

Industries involving a geographically distributed and complex technical infrastructure are faced with unique challenges in providing customers with complete services in various geographical areas. One company in such an industry may have the appropriate infrastructure for providing services in one particular geographical area but lack the resources in other areas. Moreover, another company may have the appropriate resources to complete a portion of an order but lack the resources to provide a completed order to a customer. In the telecommunications industry, for example, one provider may have infrastructure for providing data connections to customers in certain geographical areas but lack sufficient infrastructure to carry the data traffic to and from other areas. Consequently, the provider would be unable to meet the needs of a customer operating a large enterprise with a diverse set of telecommunication needs that are geographically dispersed across many facilities. Indeed, it is often the case that only the largest providers are able to effectively bid on or otherwise fulfill orders for such enterprises, thereby decreasing competition and increasing costs.

It is with these observations in mind, among others, that various aspects of the present disclosure were conceived and developed.

### SUMMARY

Implementations described and claimed herein address the foregoing problems, among others, by providing systems and methods for processing telecommunication orders taking advantage of the infrastructure and capabilities of a plurality of different providers. In one implementation, one or more databases store provider data received from a plurality of provider members. The provider data is aggregated based on at least one of a plurality of attributes associated with one or more telecommunication packages. The plurality of attributes include infrastructure information, location information, and pricing information. At least one server is in communication with the one or more databases. The at least one server is configured to generate a design for a customer order based on the aggregated provider data. The design uses at least one of the plurality of provider members to provide a customer telecommunication package at one or more customer sites. The customer telecommunication package is selected from the one or more telecommunication packages.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 is an example network environment, including an order tool running on a server or other computing device coupled with a network, for ingesting provider data and for generating a quote for providing a customer telecommunication package at one or more customer sites.

FIG. 2 illustrates example operations for processing a telecommunication order.

FIG. 3 shows an example network map user interface displaying a network infrastructure of a plurality of provider members.

FIG. 4 illustrates an example network map detail user interface displaying a zoomed in region of the network infrastructure of the plurality of provider members.

FIG. 5 shows an example design creation user interface displaying fields for inputting customer information.

FIG. 6 illustrates an example telecommunication package design definition user interface for selecting a customer telecommunication package for the customer input with the user interface of FIG. 5.

FIG. 7 displays an example a customer site design definition user interface for identifying one or more customer sites to provide the customer telecommunication package selected with the user interface of FIG. 6.

FIG. 8 illustrates an example identified customer sites user interface showing the one or more customer sites identified with the user interface of FIG. 7.

FIG. 9 shows an example quote user interface displaying a consolidated quote for providing the customer telecommunication package at the one or more customer sites defined with the user interface of FIGS. 6 and 7.

FIG. 10 is an example computing system that may be specifically configured to implement the various systems and methods discussed herein.

### DETAILED DESCRIPTION

Aspects of the present disclosure generally involve an automated portal, running on one or more server machines accessible through a network connection, through which participants in a consortium may access available packages to fulfill orders for enterprise customers with customer sites in multiple different and often remote locations. Stated differently, the participants may upload and share packages and associated data using the automated portal, which aggregates and normalizes the data. A participant may use the portal to generate a design for a customer order from the aggregated data that takes advantage of the packages offered by various participants. Such packages may include one or more services, products, systems, or the like. The participant may use the portal to generate a consolidated quote for providing the design, which may be used to competitively bid on the customer order and reduce costs.

In one aspect, the participants are provider members operating in the telecommunications industry. Such provider members may include telecommunication providers, incumbent cable companies operating as multiple system operators (MSO), and the like. An MSO often provides cable television packages along with various possible other packages, such as dedicated Internet access, voice packages, and the like, to customers within a limited geographical area. In the geographic area where the MSO operates, the MSO typically has some form of connection to customers, such as a fiber connection, a coaxial connection, or the like. Through those connections, the MSO is able to offer and provide the various telecommunication packages to customers. An MSO, however, is often unable to effectively compete for certain types of business. For example, an MSO may not be able to bid on a customer order for telecommunication packages, such as Internet Protocol (IP) Virtual Private Networks (VPN), for large geographically dispersed enterprise customers because the MSO lacks the necessary connections in many of the geographical areas in which the customer operates. Conversely, a telecommunication provider, such as a high speed network provider, may have the infrastructure and capability to carry data across wide geographic regions but lack the necessary infrastructure at the customer sites to provide some telecommunication packages.

Accordingly, the portal receives provider data from the various provider members. The provider data includes the telecommunication packages offered by each of the provider members and attributes, including location information, infrastructure information, and pricing information associated with the telecommunication packages. The portal aggregates the provider data, enabling a provider member to access the available telecommunication packages and filter options based on various attributes, such as location, infrastructure, pricing, or the like. A provider member may use the aggregated provider data to obtain a design for a customer order or proposal that takes advantage of the capabilities of other provider members. For example, an MSO in a certain geographic area might access the aggregated provider data to obtain a proposal for providing a customer telecommunication package including one or more telecommunication services, products, or systems for an enterprise customer that take advantage of the capabilities of the MSO as well as other provider members that participate in the consortium. The MSO, therefore, is able to effectively compete for the business of the enterprise customer against even the largest providers. By increasing competition, costs for such customer orders are normalized and often reduced.

The various systems and methods disclosed herein generally provide for ingesting data from a plurality of participants and for generating a design and quote for providing a customer package at one or more customer sites using the data. The example implementations discussed herein reference the telecommunication industry and provider data. However, it will be appreciated by those skilled in the art that the presently disclosed technology is applicable to other industries and data.

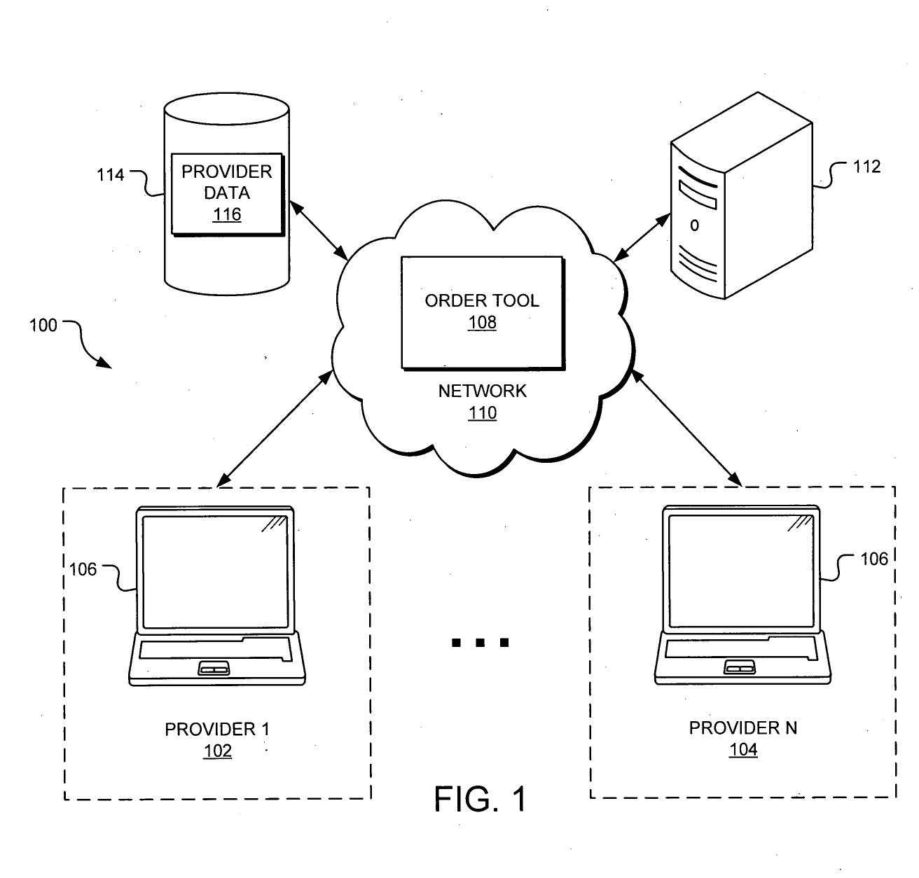

For a detailed description of an example network environment 100 for ingesting provider data and for generating a quote for providing a customer telecommunication package at one or more customer sites, reference is made to FIG. 1.

In one implementation, a plurality of providers 102, 104 (Provider 1 . . . N) utilize a user device 106 to access and interact with an order tool 108 via a network 110 (e.g., the Internet). The user device 106 is generally any form of computing device capable of interacting with the network 110, such as a personal computer, terminal, laptop, mobile device, tablet, a multimedia console, server etc.

The network environment 100 includes a server 112 configured to provide the order tool 108. In one implementation, the server 112 hosts a website or an application that the providers 102, 104 may visit to access the order tool 108. The server 112 may be a single server, a plurality of servers with each such server being a physical server or a virtual machine running on a physical server, or a collection of both physical servers and virtual machines. The server 112 is in communication with one or more databases 114 to store and receive data, including provider data 116. The user device 106, the server 112, and other resources connected to the network 110 may access one or more other servers to access one or more websites, applications, web services interfaces, storage devices, computing devices, or the like that are used to process the provider data 116. The server 112 may also host a search engine for accessing, searching for, and modifying the provider data 116.

In one implementation, the order tool 108 is configured to receive and ingest the provider data 116 from the providers 102, 104 for storage in the database 114. The providers 102, 104 may be members of a consortium that include companies operating in the telecommunication industry, such as telecommunication providers and incumbent cable companies including those operating as MSO's. The provider data 116 includes information associated with the various telecommunication packages, including one or more telecommunication services, products, and/or systems, offered by the providers 102, 104. For example, the telecommunication packages may include, without limitation, dedicated Internet access, IP VPN, voice, digital cable television, and the like.

The provider data 116 may include various attributes associated with the telecommunication packages. For example, the provider 102 may provide specific telecommunication packages to various possible customers, which may be a limited set of customers in some geographic area where the provider 102 operates. The provider 102 has the technical infrastructure to provide those specific telecommunication packages, but the infrastructure may have geographical limitations associated with it. The provider 102, thus, has infrastructure information and location information associated with the specific telecommunication packages. Moreover, the provider 102 has pricing information associated with the specific telecommunication packages, including, without limitation, the cost of the telecommunication package, installation costs, and the use of the infrastructure needed to provide the telecommunication package. The order tool 108 receives the provider data 116 from the provider 102 including the specific telecommunication packages and the associated attributes.

In one implementation, the order tool 108 receives the provider data 116 from each of the providers 102, 104 using a variety of possible mechanisms. For example, the provider 102 may connect to the order tool 108 to access and upload the provider data 116 using a browser operating on the user device 106, and the provider 104 may upload the provider data 116 to the order tool 108 using a file transfer protocol (FTP). A script or other computing mechanism may automatically upload and/or update the provider data 116 from one or more provider databases. The order tool 108 may also regularly query provider databases to obtain the initial provider data 116 and/or updated provider data 116.

The order tool 108 aggregates the provider data 116 by normalizing and establishing commonalities between the datasets received from the providers 102, 104. In one implementation, the order tool 108 aggregates the provider data based on at least one of the attributes associated with the telecommunication packages. For example, the order tool 108 may aggregate and/or group the provider data based on purchase information, infrastructure information, location information, pricing information, and/or the like. The aggregated provider data 116 is stored in the database 114.

In one implementation, any of the providers 102, 104 may use the order tool 108 to create and edit a design for providing a customer telecommunication package at one or more customer sites and to generate a consolidated quote to provide the design for the potential customer. For example, the provider 102 may access the order tool 108 via a user interface displayed in a browser window running on the user device 106. The order tool 108 may be access controlled to limit access to only those providers that are members of the consortium and have agreed to allow their infrastructures and packages to be used by other members in a design providing a telecommunication package to a customer. The order tool 108 generates the designs and the consolidated quotes based on the aggregated provider data 116, thereby taking advantage of the telecommunication packages offered from the collected set of the providers 102, 104. For example, the provider 102 may create a design and submit a quote to an enterprise customer that uses the infrastructure of the provider 102 and the provider 104. The provider 102, therefore, is able to effectively compete for the business of the enterprise customer against even the largest providers.

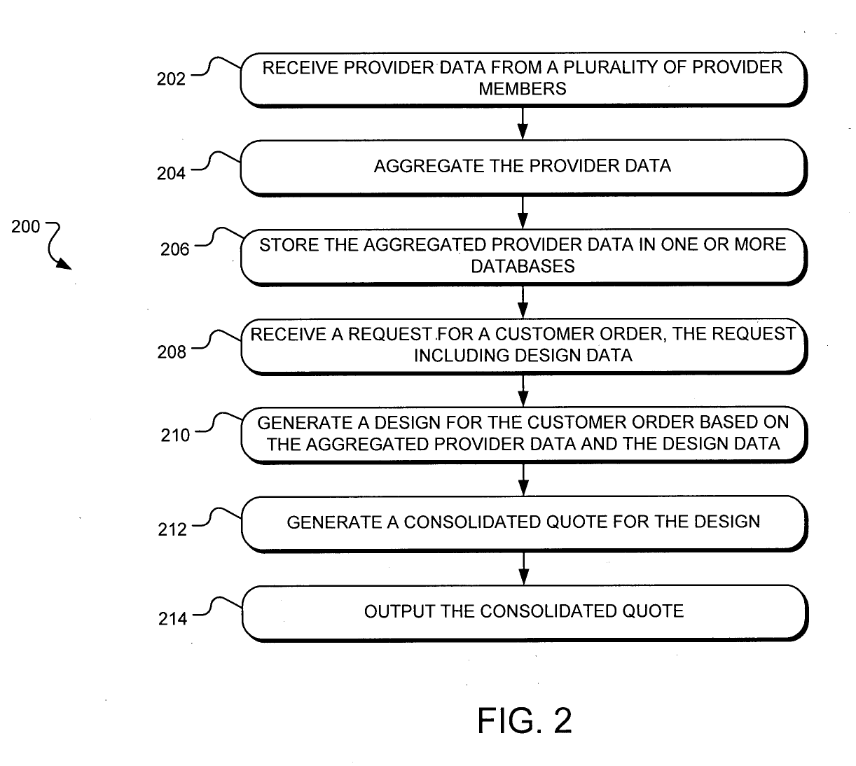

Turning to FIG. 2, example operations 200 for processing a telecommunication order are shown. In one implementation, an operation 202 receives provider data from a plurality of provider members, which may include one or more telecommunication providers and/or multiple systems operators. The operation 202 may automatically receive the provider data from one or more provider databases or other sources. Alternatively or additionally, the operation 202 may receive the provider data through manual upload.

The provider data includes telecommunication packages offered by the provider members. The telecommunication packages include one or more telecommunication services, products, systems, and/or the like. For example, the telecommunication services may include dedicated Internet access, IP VPN, voice, digital cable television, and the like. In one implementation, the provider data includes a plurality of attributes associated with the telecommunication packages. The attributes may include infrastructure information, location information, pricing information, or the like. In one implementation, the location information includes one or more geographical locations where at least one of the telecommunication packages is offered. Stated differently, the location information corresponds to the geographical locations in which one of the provider members operates and is able to provide the telecommunication package. In one implementation, the infrastructure information includes data corresponding to a configuration of an infrastructure providing the at least one of the telecommunication packages. For example, the infrastructure information may include data regarding a configuration of network components, computing devices or components, and other hardware or software used to provide the telecommunication package. The pricing information, in one implementation, includes an installation price for at least one of the telecommunication packages, a price for providing the telecommunication package, or the like. The price for providing the telecommunication package may include the cost of the telecommunication package and/or the cost of using the infrastructure needed to provide the telecommunication package.

An operation 204 aggregates the provider data. In one implementation, the operation 204 aggregates the provide data based on at least one of the attributes. For example, the operation 204 may aggregate the provider data based on location information to enable a provider member to filter the provider data based on location to view the telecommunication packages available in a specific geographic location or to view the locations in which a specific telecommunication package is available for offer. An operation 206 stores the aggregated provider data in one or more databases.

An operation 208 receives a request for a customer order. In one implementation, the request includes design data for a customer order on which a provider member would like to bid and/or for which the provider member would like to create a design. The design data includes a selection of a customer telecommunication package. In one implementation, the selection is made from a pool of available packages, which may be automatically populated based on the aggregated provider data. In another implementation, details of the customer telecommunication package are entered via a user interface. The design data further includes an identification of one or more customer sites at which the selected telecommunication package is desired. In one implementation, the customer sites are identified through manual entry of a location of each of the customer sites. For example, a street address or geographical coordinates may be manually entered for each of the customer sites. In another implementation, the customer sites are identified by transferring a location of each of the customer sites using an FTP. In still another implementation, the customer sites are identified by uploading a location of each of the customer sites into a database. The locations of the customer sites may be transferred or uploaded in bulk. In one implementation, where the locations of the customer sites are available in the database, the operation 208 may include automatically discovering the customer sites, such as by extracting one or more locations (e.g., street addresses, geographical coordinates, etc.) from customer information stored in the database, and presenting the customer sites for selection. The customer sites identified by the selection may be used in the design.

An operation 210 generates a design for the customer order based on the aggregated provider data and the design data. Stated differently, the operation 210 creates a design of the selected customer telecommunication package at the one or more customer sites to fulfill the customer order using an aggregation of the telecommunication packages available from the plurality of provider members. In one implementation, the design uses the telecommunication packages of at least two of the plurality of provider members.

An operation 212 generates a consolidated quote for the design based on the aggregated provider data. In one implementation, the operation 212 utilizes pricing information associated with the telecommunication packages used in the design to fulfill the customer order to generate the consolidated quote. An operation 214 outputs the design and/or the customer quote. In one implementation, the operation 214 outputs the design and/or the customer quote for display on a graphical user interface.

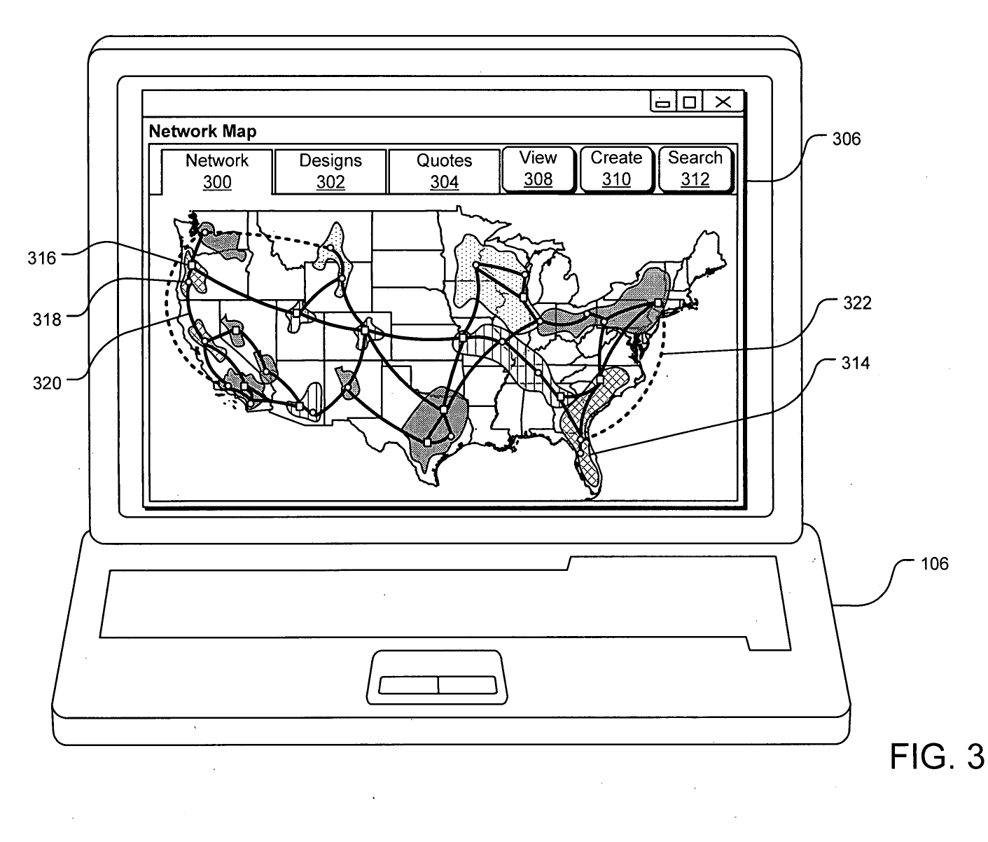

FIGS. 3-9 show example user interfaces generated by the order tool 108 and displayed in a browser window of the user device 106 through which access to and interactions with the provider data 116, designs, quotes, and other data are provided. It will be appreciated by those skilled in the art that such depictions are exemplary only and not intended to be limiting.

As can be understood from FIGS. 3-9, the order tool 108 generates user interfaces providing tabs to navigate between network information, design information, and quote information. In one implementation, selection of a network tab 300 graphically depicts a collective network infrastructure in various geographic areas, selection of a design tab 302 enables a provider member to create and edit a design for a customer order, and selection of a quote tool 304 displays consolidated quote for the design.

Turning to FIG. 3, a network map user interface 306 displays a collective network infrastructure of all the provider members. In one implementation, a view button 308 provides options for panning and zooming the view of the network map 306, as well as options to change the network map 306 to a street view, a satellite view, or a hybrid view. A create button 310 may be used to start a new design using at least some of the collective network infrastructure. A search button 312 provides the ability to search by coverage areas, fiber, provider member, location, telecommunication packages, other attributes, or the like.

As shown in FIG. 3, the network map 306 graphically depicts coverage areas and infrastructure of the provider members. In one implementation, the network map 306 shows various MSO provider network components and geographic area coverage, as well as a network infrastructure of a telecommunication provider providing a long-haul and backbone network. In the example shown in FIG. 3, the network map 306 shows the continental United States overlaid with a graphic depiction of areas of network coverage by the provider members.

The network map 306 shows different MSO networks 314 that are provider members having coverage in the continental United States. The network map 306 may visually distinguish between the various MSO networks 314 for example using color coding, pattern coding, or other visual distinguishers or cues. In the example of FIG. 3, the coverage areas of the different MSO networks 314 are shown with different patterns, including a large dotted pattern, a small dotted pattern, a cross-hatch pattern, and a vertical line pattern. Further, the network map 306 depicts the network infrastructure of a telecommunication provider, including, without limitation, on-net markets with metro capabilities 316, on-net markets 318, owned networks 320, and leased networks 322, in various geographical areas in the continental United States. In one implementation, the network map 306 further depicts the network interconnections between the telecommunication provider and the various MSO's more geographically restricted networks.

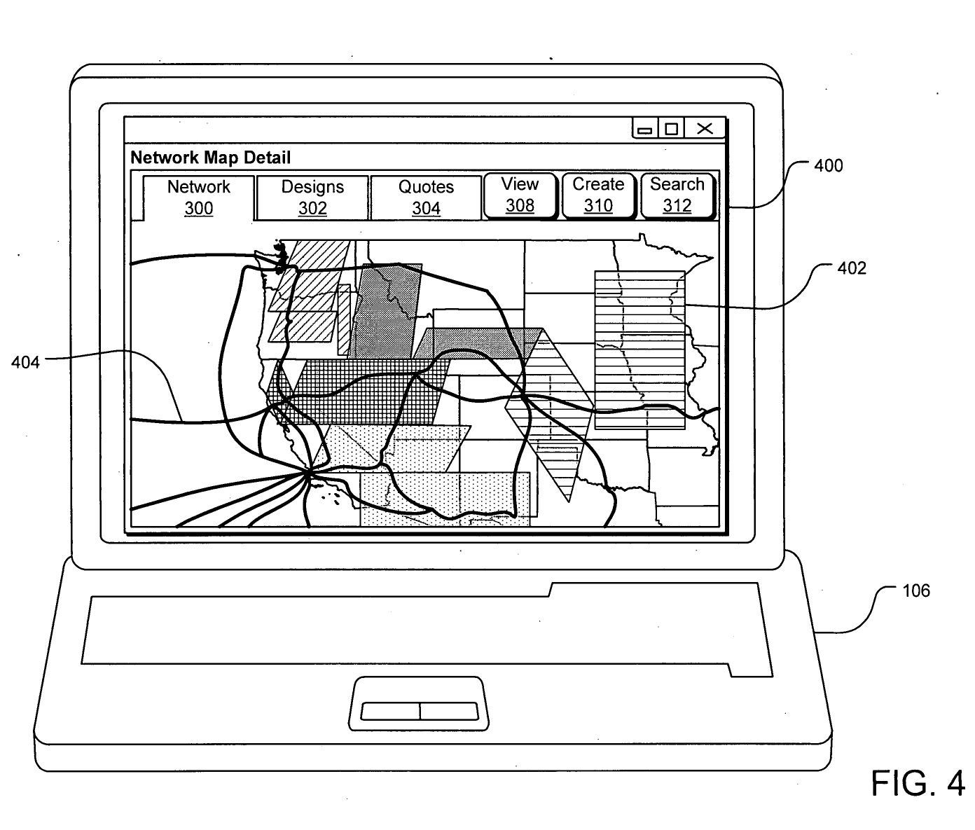

Turning to FIG. 4, an example network map detail user interface 400 displays a zoomed in region of the network infrastructure of the plurality of provider members. In one implementation, when a user zooms into a certain area of the network map 306 the MSO's having coverage 402 in the specific area, as well as the network infrastructure 404 of the telecommunication provider in the specific area is shown in more granular detail. The network map detail 400 may be used, for example, to create a design for a customer order or otherwise to obtain more detailed information of the available infrastructure, coverage, and capabilities in a specific area.

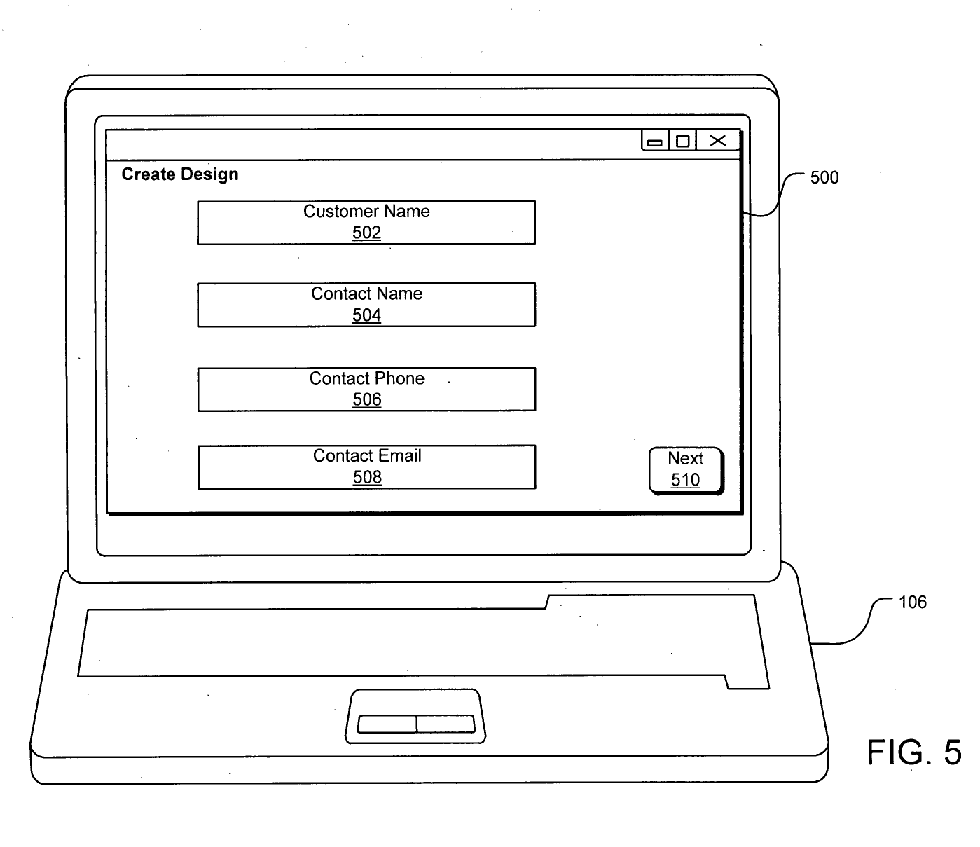

As can be understood from FIG. 5, selection of the create button 310 opens or otherwise navigates to a design creation user interface 500 displaying fields for inputting customer information. In one implementation, the customer information includes, without limitation, a customer name field 502, a contact name field 504, a contact phone field 506, a contact email field 508, and the like. When designing or editing a telecommunication package for an existing customer or a customer whose information was previously input, in one implementation, the customer name field 502 includes a drop down list or a searchable field for locating a customer name, which when selected, automatically populates the remaining fields 504-508.

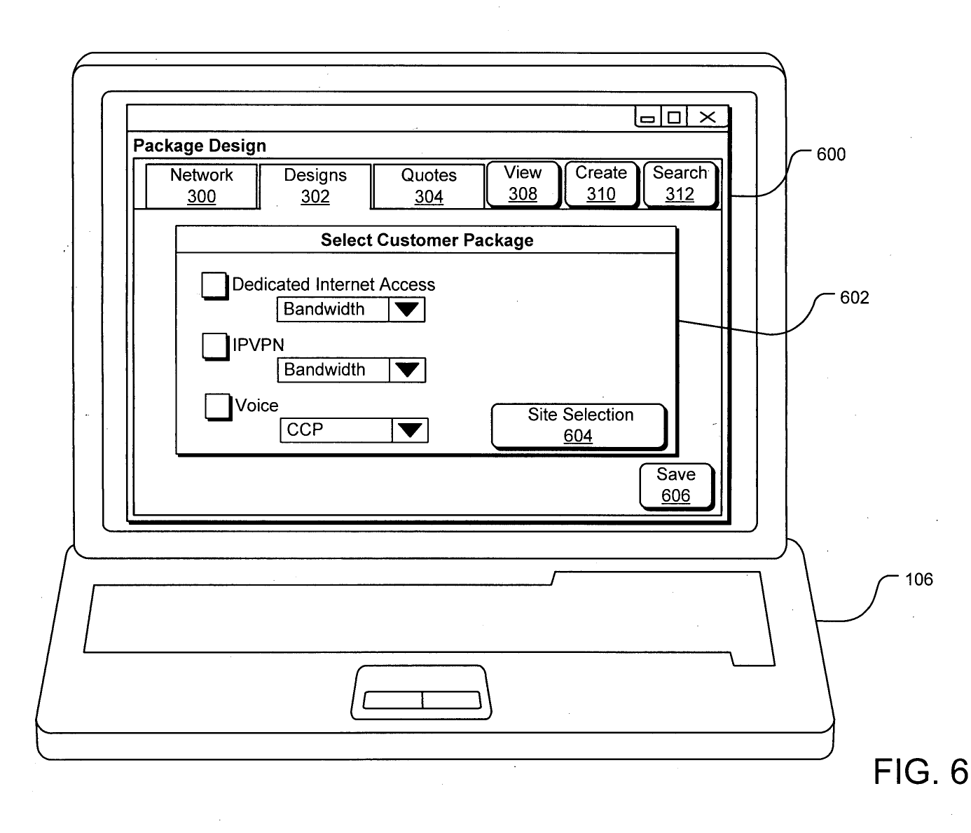

After identifying the customer, selection of a next button 510 opens or otherwise navigates to a telecommunication package design definition user interface 600 for selecting a customer telecommunication package as shown in FIG. 6. In one implementation, a pool 602 of available telecommunication packages is presented for selection, for example, using check boxes, drop down menus, and/or the like. The pool 602 may be automatically populated based on the aggregated provider data. For example, each telecommunication package offered by at least one of the provider members may be identified and included in the pool 602 for selection. In some implementations, the telecommunication packages included in the pool 602 are further categorized, for example, by provider member, location, pricing, availability, or the like. In the example shown in FIG. 6, the pool 602 includes dedicated Internet access, IP VPN, and voice for selection to define a customer telecommunication package. The pool 602 of FIG. 6 further includes drop down menus for specifying one or more parameters of the customer telecommunication package. For example, bandwidth may be defined for the dedicated Internet access and the IP VPN and concurrent call paths (CCP) may be defined for the voice services. A save button 606 may be selected to save the design, for example, for later editing or generation of a consolidated quote.

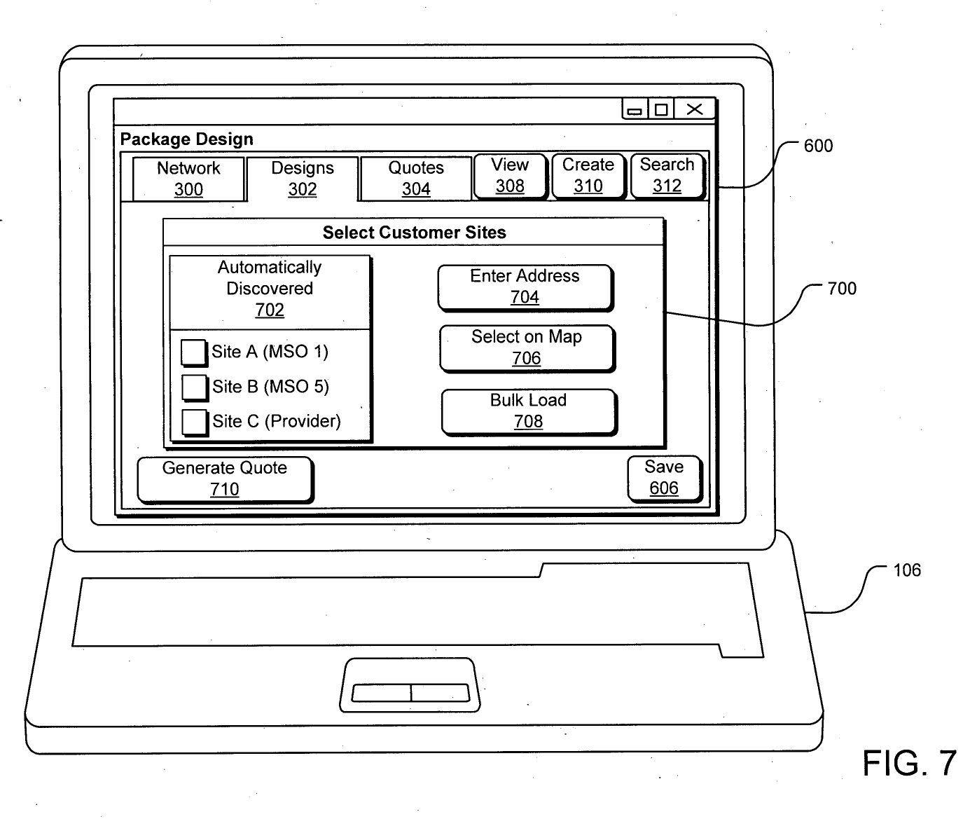

Before or after selecting the customer telecommunication package, one or more customer sites may be identified. In one implementation, a site selection button 604 opens or otherwise navigates to a customer site design definition user interface 700 for identifying one or more customer sites at which to provide the selected customer telecommunication package. As shown in FIG. 7, in one implementation, the customer site design definition user interface 700 includes various mechanisms for identifying the customer sites. For example, automatically discovered customer sites 702 may be identified from previously acquired customer information and presented for selection. One or more addresses, coordinates or other location information for the customer locations may be manually entered using an enter address field 704. A select on map option 706 may be used to identify one or more sites by selecting the locations on the network map 306. A bulk load option 708 may be used to acquire one or more addresses, coordinates or other location information for the customer locations in bulk, for example, via upload from a customer database or transfer using FTP or other transfer protocols.

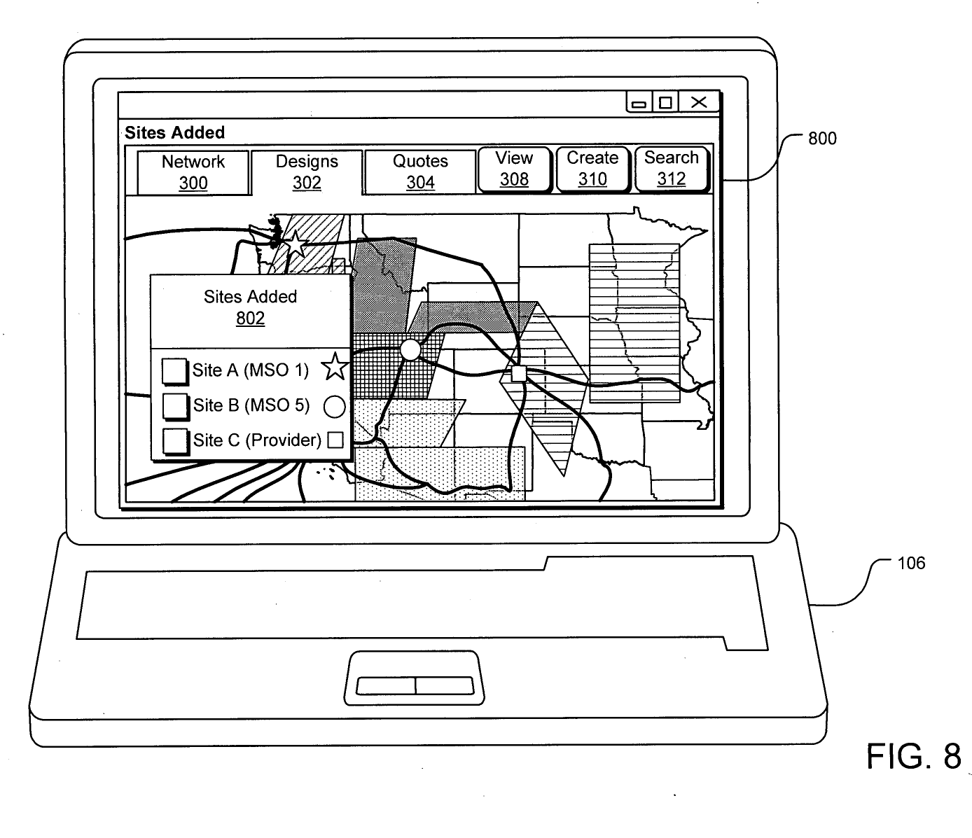

In one implementation, the customer locations include a reference to one or more provider members operating at each of the customer locations. The reference is determined based on the aggregated provider data. As shown in the example of FIG. 7, Site A is serviced by MSO 1, Site B is serviced by MSO 5, and Site C is serviced by the telecommunication provider. In one implementation, the identified customer sites may be displayed with an identified customer sites user interface 800. In the example shown in FIG. 8, a sites added window 802 lists the customer locations, along with a reference to the provider member operating at that location and a legend for identifying the site on the map. For example, Site A is serviced by MSO 1 and shown on the map as a star, Site B is serviced by MSO 5 and shown on the map as a circle, and Site C is serviced by the telecommunication provider and shown on the map as a square.

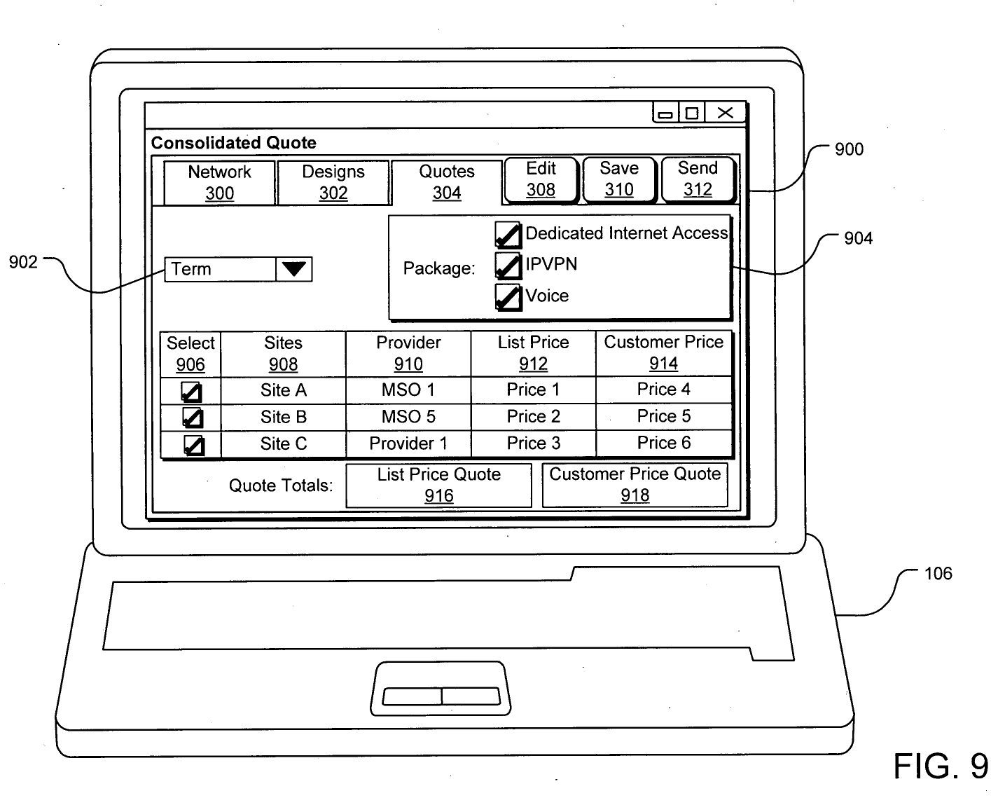

After the design is created, selection of a generate quote button 710, the quotes tab 304, or the like opens or otherwise navigates to a quote user interface 900 displaying a consolidated quote for providing the customer telecommunication package at the one or more customer sites defined with the user interfaces of FIGS. 6 and 7. In one implementation, the quote is generated for a specified term (e.g., 1 year, etc.), which may be defined using a term drop down menu or field 902. The design data for which the consolidated quote is being generated may be presented in the quote user interface 900, as shown in FIG. 9. Details of the selected customer telecommunication package 904 and the customer sites are displayed and may be edited. For example, the selected customer telecommunication package 904 shows the included telecommunication packages, which may be selected and deselected using check boxes.

Similarly, a table showing the one or more customer sites may include, without limitation: a select column 906 including check boxes indicating whether a customer site is included in the design; a sites column 908 identifying the customer site; a provider column 910 including the reference to the provider member operating at the corresponding customer site; a list price 912 for providing the selected customer telecommunication package at the corresponding customer site, including an installation price and a price for providing the package at a regular interval (e.g., a price per month for the package); and a customer price 914 that may be used in a bid for providing the selected customer telecommunication package at the corresponding customer site using normalized pricing, including an installation price and a price for providing the package at a regular interval (e.g., a price per month for the package).

In one implementation, a list price quote 916 is a sum of the list prices 912 to provide the selected telecommunication package at the identified customer sites 908, and a customer price quote 918 is a sum of the customer prices 914 to provide the selected telecommunication package at the identified customer sites 908 using the provider members 910. Stated differently, the consolidated quote shown in the customer price quote 918 may reflect discounted prices based on a normalization of pricing information, as well as the ability to taking advantage of the packages offered by the provider members 910. In one implementation, the quotes 916 and 918 include an installation price, a price for providing the package at a regular interval (e.g., a price per month for the package), a gross percentage margin, and the like. Further, editing of the design data by selecting and deselecting the check boxes 906 or included in the selected customer telecommunication package 904 may change or update the quotes 916 and 918. To otherwise edit or save the quote, the edit button 308 and the save button 310 may be used. To send the quote to an interested party, such as the customer, the send button 312 may be used, for example, to export the quote to a PDF, attached the quote to an email, print the quote, or the like.

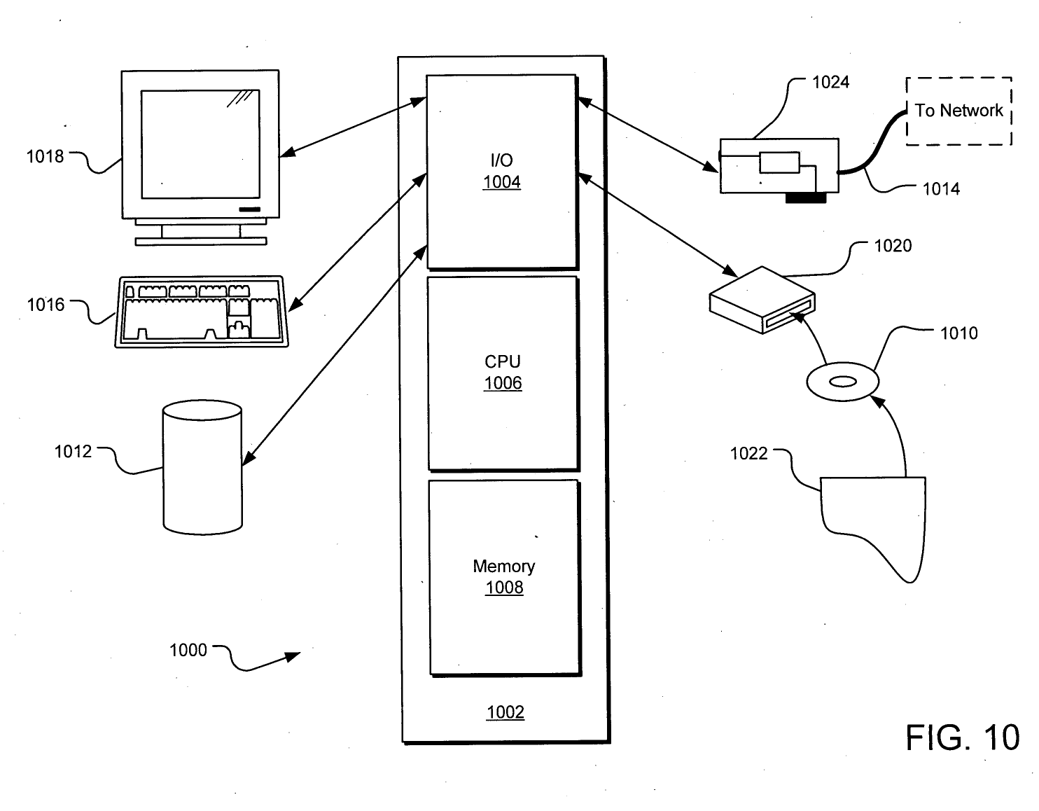

Referring to FIG. 10, a detailed description of an example computing system 1000 that may implement various systems and methods discussed herein is provided. The computing system may be applicable to the user device 106, the server 112, or other computing devices. It will be appreciated that specific implementations of these devices may be of differing possible specific computing architectures not all of which are specifically discussed herein but will be understood by those of ordinary skill in the art.

A general purpose computer system 1000 is capable of executing a computer program product to execute a computer process. Data and program files may be input to the computer system 1000, which reads the files and executes the programs therein. Some of the elements of a general purpose computer system 1000 are shown in FIG. 10 wherein a processor 1002 is shown having an input/output (I/O) section 1004, a Central Processing Unit (CPU) 1006, and a memory section 1008. There may be one or more processors 1002, such that the processor 1002 of the computer system 1000 comprises a single central-processing unit 1006, or a plurality of processing units, commonly referred to as a parallel processing environment. The computer system 1000 may be a conventional computer, a distributed computer, or any other type of computer, such as one or more external computers made available via a cloud computing architecture. The presently described technology is optionally implemented in software devices loaded in memory 1008, stored on a configured DVD/CD-ROM 1010 or storage unit 1012, and/or communicated via a wired or wireless network link 1014, thereby transforming the computer system 1000 in FIG. 10 to a special purpose machine for implementing the described operations.

The I/O section 1004 is connected to one or more user-interface devices (e.g., a keyboard 1016 and a display unit 1018), a disc storage unit 1012, and a disc drive unit 1020. In the case of a tablet or smart phone device, there may not be a physical keyboard but rather a touch screen with a computer generated touch screen keyboard. Generally, the disc drive unit 1020 is a DVD/CD-ROM drive unit capable of reading the DVD/CD-ROM medium 1010, which typically contains programs and data 1022. Computer program products containing mechanisms to effectuate the systems and methods in accordance with the presently described technology may reside in the memory section 1004, on a disc storage unit 1012, on the DVD/CD-ROM medium 1010 of the computer system 1000, or on external storage devices made available via a cloud computing architecture with such computer program products, including one or more database management products, web server products, application server products, and/or other additional software components. Alternatively, a disc drive unit 1020 may be replaced or supplemented by a floppy drive unit, a tape drive unit, or other storage medium drive unit. Similarly, the disc drive unit 1020 may be replaced or supplemented with random access memory (RAM), magnetic memory, optical memory, and/or various other possible forms of semiconductor based memories commonly found in smart phones and tablets.

The network adapter 1024 is capable of connecting the computer system 1000 to a network via the network link 1014, through which the computer system can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as Personal Digital Assistants (PDAs), mobile phones, tablets or slates, multimedia consoles, gaming consoles, set top boxes, etc.

When used in a LAN-networking environment, the computer system 1000 is connected (by wired connection or wirelessly) to a local network through the network interface or adapter 1024, which is one type of communications device. When used in a WAN-networking environment, the computer system 1000 typically includes a modem, a network adapter, or any other type of communications device for establishing communications over the wide area network. In a networked environment, program modules depicted relative to the computer system 1000 or portions thereof, may be stored in a remote memory storage device. It is appreciated that the network connections shown are examples of communications devices for and other means of establishing a communications link between the computers may be used.

In an example implementation, provider data, customer information, design data, consolidated quotes, a plurality of internal and external databases, source databases, and/or cached data on servers are stored as the memory 1008 or other storage systems, such as the disk storage unit 1012 or the DVD/CD-ROM medium 1010, and/or other external storage devices made available and accessible via a network architecture. Order tool software and other modules and services may be embodied by instructions stored on such storage systems and executed by the processor 1002.

Some or all of the operations described herein may be performed by the processor 1002. Further, local computing systems, remote data sources and/or services, and other associated logic represent firmware, hardware, and/or software configured to control operations of the order tool 108, the user devices 106, and/or other components of the network environment 100. Such services may be implemented using a general purpose computer and specialized software (such as a server executing service software), a special purpose computing system and specialized software. (such as a mobile device or network appliance executing service software), or other computing configurations. In addition, one or more functionalities disclosed herein may be generated by the processor 1002 and a user may interact with a Graphical User Interface (GUI) using one or more user-interface devices (e.g., the keyboard 1016, the display unit 1018, and the user devices 106) with some of the data in use directly coming from online sources and data stores. The system set forth in FIG. 10 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for ingesting telecommunications orders comprising:
receiving, using at least one processor, provider data from a plurality of provider members, the provider data including a plurality of attributes associated with one or more telecommunication packages, the plurality of attributes including infrastructure information, location information, and pricing information;
aggregating the provider data by at least one of the plurality of attributes using the at least one processor; and
storing the aggregated provider data in one or more databases.

2. The method of claim 1, wherein the plurality of provider members includes at least one telecommunication provider and at least one multiple systems operator.

3. The method of claim 1, wherein the telecommunications packages include one or more telecommunication services.

4. The method of claim 3, wherein the telecommunication services include at least one of: dedicated Internet access, an Internet Protocol virtual private network, voice services, or cable television.

5. The method of claim 1, wherein the provider data is automatically received from one or more provider databases.

6. The method of claim 1, wherein the location information includes one or more geographical locations where at least one of the telecommunication packages is offered.

7. The method of claim 1, wherein the pricing information includes at least one of an installation price for at least one of the telecommunication packages or a price for providing at least one of the telecommunication packages.

8. The method of claim 1, wherein the infrastructure information includes data corresponding to a configuration of an infrastructure providing at least one of the telecommunication packages.

9. The method of claim 1, further comprising:
generating a consolidated quote for a customer telecommunications package based on the aggregated provider data.

10. One or more non-transitory tangible computer-readable storage media storing computer-executable instructions for performing a computer process on a computing system, the computer process comprising:
receiving a selection of a telecommunication package made from a pool of available packages;
receiving an identification of one or more customer sites;
generating a design for a customer order based on aggregated provider data, the design using a plurality of provider members to provide the selected telecommunication package at the one or more customer sites; and
generating a consolidated quote for the design based on the aggregated provider data.

11. The one or more non-transitory tangible computer-readable storage media of claim 10, further comprising:
outputting the design for display on a graphical user interface.

12. The one or more non-transitory tangible computer-readable storage media of claim 10, wherein the plurality of provider members includes at least one telecommunication provider and at least one multiple systems operator.

13. The one or more non-transitory tangible computer-readable storage media of claim 10, wherein the selected telecommunications package includes one or more telecommunication services.

14. The one or more non-transitory tangible computer-readable storage media of claim 10, wherein the pool of available packages is automatically populated based on the aggregated provider data.

15. The one or more non-transitory tangible computer-readable storage media of claim 10, wherein the customer sites are identified by at least one of: manual entry of a location of each of the one or more customer sites; transferring a location of each of the one or more customer sites using a file transfer protocol; or uploading a location of each of the one or more customer sites into a database.

16. A system for processing telecommunication orders comprising:
one or more databases storing provider data received from a plurality of provider members, the provider data aggregated based on at least one of a plurality of attributes associated with one or more telecommunication packages, the plurality of attributes including infrastructure information, location information, and pricing information; and
at least one server in communication with the one or more databases, the at least one server configured to generate a design for a customer order based on the aggregated provider data, the design using at least one of the plurality of provider members to provide a customer telecommunication package at one or more customer sites, the customer telecommunication package selected from the one or more telecommunication packages.

17. The system of claim 16, wherein the at least one server is further configured to generate a consolidated quote for the design based on the aggregated provider data.

18. The system of claim 16, wherein the plurality of provider members includes at least one telecommunication provider and at least one multiple systems operator.

19. The system of claim 16, wherein the one or more telecommunication packages include one or more telecommunication services.

20. The system of claim 16, wherein the at least one server is further configured to output the design for display on a graphical user interface.
